(19) United States
(12) Patent Application Publication
(10) Pub. No.: US 2026/0282041 A1
(43) Pub. Date: Sep. 17, 2026

(54) METHOD AND APPARATUS FOR GENERATING HARQ-ACK INFORMATION ASSOCIATED WITH SIDELINK TRANSMISSION FOR PUCCH TRANSMISSION

(71) Applicant: LENOVO (BEIJING) LIMITED, Beijing (CN)

(72) Inventors: Haipeng Lei, Beijing (CN); Zhennian Sun, Beijing (CN); Xin Guo, Beijing (CN)

(21) Appl. No.: 19/168,189

(22) PCT Filed: Jul. 28, 2023
(86) PCT No.: PCT/CN2023/110022

§ 371 Date: Sep. 23, 2025

(51) Int. Cl. H04W 72/25; H04L 1/1812; H04W 72/1273; H04W 72/21

(52) U.S. Cl. CPC H04W 72/25; H04L 1/1812; H04W 72/1273; H04W 72/21

(57) ABSTRACT

Embodiments of the present disclosure relate to method and apparatus for generating HARQ-ACK information associated with sidelink transmission for PUCCH transmission. According to some embodiments of the disclosure, a first UE may: receive, from a BS, a DCI format for scheduling a resource or activating a configured grant for transmitting a PSSCH; transmit, to a second UE, the PSSCH based on the DCI format, wherein sidelink HARQ-ACK feedback for the PSSCH is to be transmitted by the second UE in a plurality of candidate PSFCH transmission occasions; detect the sidelink HARQ-ACK feedback for the PSSCH in one or more of the plurality of candidate PSFCH transmission occasions; and determine, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first PUCCH transmission occasion of a plurality of PUCCH transmission occasions.

### TECHNICAL FIELD

Embodiments of the present disclosure generally relate to wireless communication technology, and more particularly to generating hybrid automatic repeat request acknowledgement (HARQ-ACK) information associated with a sidelink transmission for a physical uplink control channel (PUCCH) transmission.

### BACKGROUND

A wireless communication system may include one or multiple network communication devices, such as base stations, which may support wireless communication for one or multiple user communication devices, which may be otherwise known as user equipment (UE), or other suitable terminology. The wireless communication system may support wireless communication with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communication system may support wireless communication across various radio access technologies including third generation (3G) radio access technology, fourth generation (4G) radio access technology, fifth generation (5G) (which is also known as new radio (NR)) radio access technology, among other suitable radio access technologies beyond 5G (e.g., sixth generation (6G)).

A wireless communication system may support sidelink communications, in which devices (e.g., UEs) may communicate with one another directly via a sidelink, rather than being linked through a base station (BS). The term “sidelink” may refer to a radio link established for communicating among devices (e.g., UEs), as opposed to communicating via the cellular infrastructure (e.g., uplink and downlink). Sidelink transmission may be performed on a licensed spectrum or an unlicensed spectrum.

There is a need for handling sidelink transmissions on an unlicensed spectrum.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some embodiments of the present disclosure provide a first UE. The first UE may include at least one memory; and at least one processor coupled with the at least one memory and configured to cause the first UE to: receive, from a BS, a downlink control information (DCI) format for scheduling a resource or activating a configured grant for transmitting a physical sidelink shared channel (PSSCH); transmit, to a second UE, the PSSCH based on the DCI format, wherein sidelink hybrid automatic repeat request acknowledgement (HARQ-ACK) feedback for the PSSCH is to be transmitted by the second UE in a plurality of candidate physical sidelink feedback channel (PSFCH) transmission occasions; detect the sidelink HARQ-ACK feedback for the PSSCH in one or more of the plurality of candidate PSFCH transmission occasions; and determine, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first physical uplink control channel (PUCCH) transmission occasion of a plurality of PUCCH transmission occasions.

In some embodiments, the HARQ-ACK information corresponding to the PSSCH indicates one of the following three states: a first state indicating an ACK corresponding to the PSSCH; a second state indicating a NACK corresponding to the PSSCH; and a third state indicating one of the following: the sidelink HARQ-ACK feedback for the PSSCH is to be reported in a later PUCCH transmission occasion of the plurality of PUCCH transmission occasions; the sidelink HARQ-ACK feedback is pending in the first PUCCH transmission occasion; and the sidelink HARQ-ACK feedback is not obtained in a candidate PSFCH transmission occasion(s) before the first PUCCH transmission occasion in the plurality of candidate PSFCH transmission occasions and will be reported in a later PUCCH transmission occasion of the plurality of PUCCH transmission occasions.

In some embodiments, the HARQ-ACK information corresponding to the PSSCH is determined as the third state in response to one of the following: the PSSCH is associated with a unicast transmission, the first UE does not detect any sidelink HARQ-ACK feedback for the PSSCH before the first PUCCH transmission occasion and the plurality of candidate PSFCH transmission occasions includes at least one candidate PSFCH transmission occasion after the first PUCCH transmission occasion; the PSSCH is associated with a groupcast transmission with UE-specific ACK/NACK feedback to a group of UEs including the second UE, the plurality of candidate PSFCH transmission occasions includes at least one candidate PSFCH transmission occasion after the first PUCCH transmission occasion and the first UE does not receive a NACK from any UE in the group of UEs in any PSFCH transmission occasion before the first PUCCH transmission occasion among the plurality of candidate PSFCH transmission occasions; and the PSSCH is associated with a groupcast transmission with NACK-only based feedback to a group of UEs including the second UE, the plurality of candidate PSFCH transmission occasions includes at least one candidate PSFCH transmission occasion after the first PUCCH transmission occasion and the first UE does not receive a NACK in any PSFCH transmission occasion before the first PUCCH transmission occasion among the plurality of candidate PSFCH transmission occasions.

In some embodiments, the HARQ-ACK information corresponding to the PSSCH is determined as the first state in response to one of the following: the PSSCH is associated with a groupcast transmission with UE-specific ACK/NACK feedback to a group of UEs including the second UE and the first UE receives ACKs from all UEs in the group of UEs in the plurality of candidate PSFCH transmission occasions; and the PSSCH is associated with a groupcast transmission with NACK-only based feedback to a group of UEs including the second UE, the plurality of candidate PSFCH transmission occasions does not include a candidate PSFCH transmission occasion after the first PUCCH transmission occasion, and the first UE does not receive a NACK in all of the plurality of candidate PSFCH transmission occasions.

In some embodiments, the HARQ-ACK information corresponding to the PSSCH is determined as the second state in response to one of the following: the PSSCH is associated with a unicast transmission, the first UE does not detect any sidelink HARQ-ACK feedback for the PSSCH before the first PUCCH transmission occasion and the plurality of candidate PSFCH transmission occasions does not include a candidate PSFCH transmission occasion after the first PUCCH transmission occasion; the PSSCH is associated with a groupcast transmission with UE-specific ACK/NACK feedback to a group of UEs including the second UE and the first UE receives a NACK from any UE in the group of UEs in any PSFCH transmission occasion before the first PUCCH transmission occasion among the plurality of candidate PSFCH transmission occasions; the PSSCH is associated with a groupcast transmission with UE-specific ACK/NACK feedback to a group of UEs including the second UE, the plurality of candidate PSFCH transmission occasions does not include a candidate PSFCH transmission occasion after the first PUCCH transmission occasion, and the first UE does not receive ACKs from all UEs in the group of UEs in the plurality of candidate PSFCH transmission occasions; the PSSCH is associated with a groupcast transmission with NACK-only based feedback to a group of UEs including the second UE and the first UE receives at least one NACK in any PSFCH transmission occasion before the first PUCCH transmission occasion among the plurality of candidate PSFCH transmission occasions; and a channel access procedure before the transmission of the PSSCH is failed at the first UE and the first UE does not transmit the PSSCH.

In some embodiments, to determine the HARQ-ACK information corresponding to the PSSCH, the at least one processor is configured to cause the first UE to determine that the HARQ-ACK information corresponding to the PSSCH is the same as the sidelink HARQ-ACK feedback for the PSSCH in response to the PSSCH being associated with a unicast transmission and the sidelink HARQ-ACK feedback for the PSSCH being detected in any candidate PSFCH transmission occasion before the first PUCCH transmission occasion among the plurality of candidate PSFCH transmission occasions.

In some embodiments, the HARQ-ACK information corresponding to the PSSCH includes at least two bits to indicate the first, second or third state. The at least one processor is further configured to cause the first UE to transmit the HARQ-ACK information corresponding to the PSSCH to the BS in the first PUCCH transmission occasion.

In some embodiments, the HARQ-ACK information corresponding to the PSSCH includes at least one bit to indicate the first state or the second state. In the case that the HARQ-ACK information corresponding to the PSSCH is determined as the third state, the at least one processor is further configured to cause the first UE to not transmit the HARQ-ACK information in the first PUCCH transmission occasion.

In some embodiments, the at least one processor is further configured to cause the first UE to: transmit the HARQ-ACK information corresponding to the PSSCH in each of the plurality of PUCCH transmission occasions; or transmit the HARQ-ACK information indicating an ACK or a NACK corresponding to the PSSCH in the first PUCCH transmission occasion of the plurality of PUCCH transmission occasions and not transmit the HARQ-ACK information in the subsequent PUCCH transmission occasion(s) after the first PUCCH transmission occasion in the plurality of PUCCH transmission occasions.

In some embodiments, the at least one processor is further configured to cause the first UE to: transmit the HARQ-ACK information indicating an ACK or a NACK corresponding to the PSSCH in the first PUCCH transmission occasion of the plurality of PUCCH transmission occasions and the subsequent PUCCH transmission occasion(s) after the first PUCCH transmission occasion in the plurality of PUCCH transmission occasions and not transmit the HARQ-ACK information corresponding to the PSSCH in each PUCCH transmission occasion before the first PUCCH transmission occasion in the plurality of PUCCH transmission occasions; or transmit the HARQ-ACK information indicating an ACK or a NACK corresponding to the PSSCH in the first PUCCH transmission occasion and not transmit the HARQ-ACK information in all subsequent PUCCH transmission occasions in the plurality of PUCCH transmission occasions.

Some embodiments of the present disclosure provide a BS. The BS may include at least one memory; and at least one processor coupled with the at least one memory and configured to cause the BS to: transmit, to a first UE, a DCI format for scheduling a resource or activating a configured grant for the first UE to transmit a PSSCH; detect HARQ-ACK information corresponding to the PSSCH in a first PUCCH transmission occasion of a plurality of PUCCH transmission occasions, wherein the HARQ-ACK information corresponding to the PSSCH is determined by the first UE based on received sidelink HARQ-ACK feedback for the PSSCH in one or more of a plurality of candidate PSFCH reception occasions or an absence of the sidelink HARQ-ACK feedback in the one or more of the plurality of candidate PSFCH reception occasions; and determine to transmit another DCI format for scheduling retransmission of the PSSCH in response to a NACK being detected in the first PUCCH transmission occasion.

In some embodiments, the HARQ-ACK information corresponding to the PSSCH indicates one of the following three states: a first state indicating an ACK corresponding to the PSSCH; a second state indicating a NACK corresponding to the PSSCH; and a third state indicating one of the following: the sidelink HARQ-ACK feedback for the PSSCH is to be reported by the first UE in a later PUCCH transmission occasion of the plurality of PUCCH transmission occasions; the sidelink HARQ-ACK feedback is pending in the first PUCCH transmission occasion; and the sidelink HARQ-ACK feedback is not obtained by the first UE in a candidate PSFCH reception occasion(s) before the first PUCCH transmission occasion in the plurality of candidate PSFCH reception occasions and will be reported by the first UE in a later PUCCH transmission occasion of the plurality of PUCCH transmission occasions.

In some embodiments, the HARQ-ACK information corresponding to the PSSCH indicates the third state in response to one of the following: the PSSCH is associated with a unicast transmission, the first UE does not detect any sidelink HARQ-ACK feedback for the PSSCH before the first PUCCH transmission occasion and the plurality of candidate PSFCH reception occasions includes at least one candidate PSFCH reception occasion after the first PUCCH transmission occasion; the PSSCH is associated with a groupcast transmission with UE-specific ACK/NACK feedback to a group of UEs, the plurality of candidate PSFCH reception occasions includes at least one candidate PSFCH reception occasion after the first PUCCH transmission occasion and the first UE does not receive a NACK from any UE in the group of UEs in any PSFCH reception occasion before the first PUCCH transmission occasion among the plurality of candidate PSFCH reception occasions; and the PSSCH is associated with a groupcast transmission with NACK-only based feedback to a group of UEs, the plurality of candidate PSFCH reception occasions includes at least one candidate PSFCH reception occasion after the first PUCCH transmission occasion and the first UE does not receive a NACK in any PSFCH reception occasion before the first PUCCH transmission occasion among the plurality of candidate PSFCH reception occasions.

In some embodiments, the HARQ-ACK information corresponding to the PSSCH indicates the first state in response to one of the following: the PSSCH is associated with a groupcast transmission with UE-specific ACK/NACK feedback to a group of UEs and the first UE receives ACKs from all UEs in the group of UEs in the plurality of candidate PSFCH reception occasions; and the PSSCH is associated with a groupcast transmission with NACK-only based feedback to a group of UEs, the plurality of candidate PSFCH reception occasions does not include a candidate PSFCH reception occasion after the first PUCCH transmission occasion, and the first UE does not receive a NACK in all of the plurality of candidate PSFCH reception occasions.

In some embodiments, the HARQ-ACK information corresponding to the PSSCH indicates the second state in response to one of the following: the PSSCH is associated with a unicast transmission, the first UE does not detect any sidelink HARQ-ACK feedback for the PSSCH before the first PUCCH transmission occasion and the plurality of candidate PSFCH reception occasions does not include a candidate PSFCH reception occasion after the first PUCCH transmission occasion; the PSSCH is associated with a groupcast transmission with UE-specific ACK/NACK feedback to a group of UEs and the first UE receives a NACK from any UE in the group of UEs in any PSFCH reception occasion before the first PUCCH transmission occasion among the plurality of candidate PSFCH reception occasions; the PSSCH is associated with a groupcast transmission with UE-specific ACK/NACK feedback to the group of UEs, the plurality of candidate PSFCH reception occasions does not include a candidate PSFCH reception occasion after the first PUCCH transmission occasion, and the first UE does not receive ACKs from all UEs in the group of UEs in the plurality of candidate PSFCH reception occasions; the PSSCH is associated with a groupcast transmission with NACK-only based feedback to a group of UEs and the first UE receives at least one NACK in any PSFCH reception occasion before the first PUCCH transmission occasion among the plurality of candidate PSFCH reception occasions; and a channel access procedure before the transmission of the PSSCH is failed at the first UE and the first UE does not transmit the PSSCH.

In some embodiments, the HARQ-ACK information corresponding to the PSSCH is the same as the sidelink HARQ-ACK feedback for the PSSCH in response to the PSSCH being associated with a unicast transmission and the sidelink HARQ-ACK feedback for the PSSCH being detected by the first UE in any candidate PSFCH reception occasion before the first PUCCH transmission occasion among the plurality of candidate PSFCH reception occasions.

In some embodiments, the HARQ-ACK information corresponding to the PSSCH includes at least two bits to indicate the first, second or third state. The at least one processor is further configured to cause the BS to receive the HARQ-ACK information corresponding to the PSSCH in the first PUCCH transmission occasion.

In some embodiments, the HARQ-ACK information corresponding to the PSSCH includes at least one bit to indicate the first state or the second state. The at least one processor is further configured to cause the BS to determine that the HARQ-ACK information corresponding to the PSSCH indicates the third state in response to that the BS does not detect the HARQ-ACK information in the first PUCCH transmission occasion.

In some embodiments, the at least one processor is further configured to cause the BS to: detect the HARQ-ACK information corresponding to the PSSCH in each of the plurality of PUCCH transmission occasions; or detect the HARQ-ACK information corresponding to the PSSCH from an earliest PUCCH transmission occasion of the plurality of PUCCH transmission occasions until an ACK or a NACK corresponding to the PSSCH is received by the BS in one of the plurality of PUCCH transmission occasions, and ignore the subsequent PUCCH transmission occasion(s) of the plurality of PUCCH transmission occasions.

Some embodiments of the present disclosure provide a processor. The processor may include at least one controller coupled with at least one memory and configured to cause the processor to: receive, from a BS, a DCI format for scheduling a resource or activating a configured grant for transmitting a PSSCH; transmit, to a second UE, the PSSCH based on the DCI format, wherein sidelink HARQ-ACK feedback for the PSSCH is to be transmitted by the second UE in a plurality of candidate PSFCH transmission occasions; detect the sidelink HARQ-ACK feedback for the PSSCH in one or more of the plurality of candidate PSFCH transmission occasions; and determine, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first PUCCH transmission occasion of a plurality of PUCCH transmission occasions.

Some embodiments of the present disclosure provide a processor. The processor may include at least one controller coupled with at least one memory and configured to cause the processor to: transmit, to a first UE, a DCI format for scheduling a resource or activating a configured grant for the first UE to transmit a PSSCH; detect HARQ-ACK information corresponding to the PSSCH in a first PUCCH transmission occasion of a plurality of PUCCH transmission occasions, wherein the HARQ-ACK information corresponding to the PSSCH is determined by the first UE based on received sidelink HARQ-ACK feedback for the PSSCH in one or more of a plurality of candidate PSFCH reception occasions or an absence of the sidelink HARQ-ACK feedback in the one or more of the plurality of candidate PSFCH reception occasions; and determine to transmit another DCI format for scheduling retransmission of the PSSCH in response to a NACK being detected in the first PUCCH transmission occasion.

Some embodiments of the present disclosure provide a method for wireless communication. The method may include: receiving, from a BS, a DCI format for scheduling a resource or activating a configured grant for transmitting a PSSCH; transmitting, to a second UE, the PSSCH based on the DCI format, wherein sidelink HARQ-ACK feedback for the PSSCH is to be transmitted by the second UE in a plurality of candidate PSFCH transmission occasions; detecting the sidelink HARQ-ACK feedback for the PSSCH in one or more of the plurality of candidate PSFCH transmission occasions; and determining, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first PUCCH transmission occasion of a plurality of PUCCH transmission occasions.

Some embodiments of the present disclosure provide a method for wireless communication. The method may include: transmitting, to a first UE, a DCI format for scheduling a resource or activating a configured grant for the first UE to transmit a PSSCH; detecting HARQ-ACK information corresponding to the PSSCH in a first PUCCH transmission occasion of a plurality of PUCCH transmission occasions, wherein the HARQ-ACK information corresponding to the PSSCH is determined by the first UE based on received sidelink HARQ-ACK feedback for the PSSCH in one or more of a plurality of candidate PSFCH reception occasions or an absence of the sidelink HARQ-ACK feedback in the one or more of the plurality of candidate PSFCH reception occasions; and determining to transmit another DCI format for scheduling retransmission of the PSSCH in response to a NACK being detected in the first PUCCH transmission occasion.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates example PUCCH transmission occasions in accordance with some embodiments of the present disclosure;

FIG. 3 illustrates a schematic diagram for HARQ-ACK information generation for PUCCH transmissions in accordance with some embodiments of the present disclosure;

FIGS. 4 and 5 illustrate flowcharts of methods for wireless communication in accordance with some embodiments of the present disclosure;

FIG. 6 illustrates a block diagram of an exemplary apparatus in accordance with some embodiments of the present disclosure;

FIG. 7 illustrates an example of a UE in accordance with some embodiments of the present disclosure;

FIG. 8 illustrates an example of a processor in accordance with some embodiments of the present disclosure; and

FIG. 9 illustrates an example of a network equipment (NE) in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G NR or 6G, 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

In resource allocation mode 1 for sidelink transmissions, a BS may assign a PUCCH resource for a UE to transmit HARQ-ACK information associated with the sidelink transmissions. For sidelink communications on an unlicensed spectrum, sidelink HARQ-ACK feedback for a single PSSCH can have more than one PSFCH transmission occasion (e.g., up to 4 PSFCH transmission occasions). Correspondingly, there may be, for example, up to 4 PUCCH transmission occasions on the licensed carrier with one PUCCH corresponding to one PSFCH. It is unclear how to determine HARQ-ACK information associated with the PSSCH that can be transmitted in the multiple PUCCH transmission occasions. It is also unclear how to transmit the generated HARQ-ACK information in the multiple PUCCH transmission occasions.

Embodiments of the present disclosure provide solutions for facilitating HARQ-ACK information generation and PUCCH transmission. The HARQ-ACK information to be transmitted in a PUCCH on a licensed carrier can be generated or determined based on HARQ-ACK feedback for a sidelink transmission on an unlicensed spectrum. By adopting the proposed solutions, spectrum utilization efficiency can be further increased with simple UE implementation.

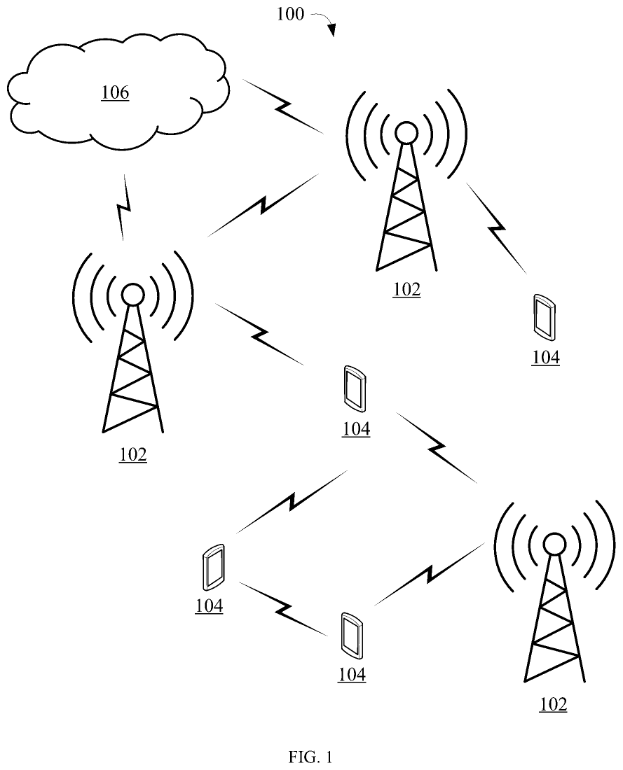

FIG. 1 illustrates a schematic diagram of wireless communication system 100 in accordance with some embodiments of the present disclosure.

The wireless communication system 100 may include one or more NEs 102 (e.g., one or more BSs), one or more UEs 104, and a core network (CN) 106. The wireless communication system 100 may support various radio access technologies. In some implementations, the wireless communication system 100 may be a 4G network, such as an LTE network or an LTE-Advanced (LTE-A) network. In some other implementations, the wireless communication system 100 may be a NR network, such as a 5G network, a 5G-Advanced (5G-A) network, or a 5G ultra-wideband (5G-UWB) network. In other implementations, the wireless communication system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communication system 100 may support radio access technologies beyond 5G, for example, 6G. Additionally, the wireless communication system 100 may support technologies, such as time division multiple access (TDMA), frequency division multiple access (FDMA), or code division multiple access (CDMA), etc.

The one or more NEs 102 may be dispersed throughout a geographic region to form the wireless communication system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with a different NE 102.

The one or more UEs 104 may be dispersed throughout a geographic region of the wireless communication system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communication with the CN 106, or with another NE 102, or both. For example, an NE 102 may interface with another NE 102 or the CN 106 through one or more backhaul links (e.g., S1, N2, N3 or another network interface). In some implementations, the NE 102 may communicate with each other directly. In some other implementations, the NE 102 may communicate with each other or indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communication system 100, the NEs 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communication). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communication system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communication system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communication system 100, an electromagnetic (EM) spectrum may be split, based on frequency or wavelength, into various classes, frequency bands, frequency channels, etc. Byway of example, the wireless communication system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communication over one or more of the operating frequency bands. In some implementations, FR1 may be used by the NEs 102 and the UEs 104, among other equipment or devices for cellular communication traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A UE 104 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, a UE 104 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, a UE 104 includes wearable devices, such as smart watches, fitness bands, optical head-mounted displays, or the like. Moreover, a UE 104 may be referred to as a subscriber unit, a mobile, a mobile station, a user, a terminal, a mobile terminal, a wireless terminal, a fixed terminal, a subscriber station, a user terminal, or a device, or described using other terminology used in the art. A UE 104 may communicate with an NE 102 (e.g., a BS) via uplink (UL) communication signals. An NE 102 may communicate with a UE 104 via downlink (DL) communication signals.

In some embodiments of the present disclosure, an NE 102 and a UE 104 may communicate over licensed spectrums, whereas in some other embodiments, an NE 102 and a UE 104 may communicate over unlicensed spectrums. The present disclosure is not intended to be limited to the implementation of any particular wireless communication system architecture or protocol.

Sidelink transmission may involve a physical sidelink control channel (PSCCH) and an associated PSSCH, which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner.

The PSSCH may carry data which may require corresponding HARQ-ACK feedback from the Rx UE(s) to the Tx UE. In some embodiments, broadcast transmission may not need HARQ-ACK feedback. In some embodiments, unicast and groupcast transmission may enable HARQ-ACK feedback under some preconditions. The HARQ-ACK feedback for a PSSCH may be carried on a physical sidelink feedback channel (PSFCH).

Several resource allocation modes (e.g., resource allocation mode 1 and resource allocation mode 2) can be employed for a sidelink transmission. Resource allocation mode 1 is based on the scheduling of a BS. Resource allocation mode 2 is based on the autonomous selection of a UE. The specific definitions of the two modes are described in 3GPP specifications.

In resource allocation mode 1, resources maybe assigned by a BS via dynamic scheduling or a configured grant. For example, a BS may transmit a DCI format (e.g., DCI format 30) to a UE (e.g., Tx UE) to indicate the time-frequency resource for sidelink transmissions (e.g., a PSCCH(s) and a PSSCH(s)) or to activate a configured grant for the sidelink transmissions. The DCI format may also indicate PSFCH-to-PUCCH timing and a PUCCH resource(s) for the Tx UE to report HARQ-ACK information associated with the sidelink transmissions to the BS. For example, after receiving sidelink HARQ-ACK feedback on a PSFCH(s) from an Rx UE(s), the Tx UE may transmit a PUCCH carrying the HARQ-ACK information associated with the sidelink transmissions to the BS in the indicated PUCCH resource. If the Tx UE transmits a “negative ACK (NACK)” to the BS in the PUCCH resource, then the BS knows that the Tx UE has not successfully transmitted its data to the Rx UE(s) and may schedule resources for the Tx UE to retransmit its data to the Rx UE(s). If the Tx UE transmits an “ACK” to the BS in the PUCCH resource, then the BS knows that the Tx UE has already successfully transmitted its data to the Rx UE(s) and may not schedule resources for the Tx UE for retransmission. Hence, for each transport block (TB) or PSSCH in resource allocation mode 1, the BS may assign a relevant PUCCH resource and indicate it to the Tx UE in the corresponding DCI format.

Accordingly, the Tx UE can be provided with PUCCH resources or physical uplink shared channel (PUSCH) resources to report HARQ-ACK information associated with the sidelink transmissions to the BS. The HARQ-ACK information associated with the sidelink transmissions may be generated based on HARQ-ACK feedback for the sidelink transmissions obtained by the Tx UE from PSFCH receptions from the Rx UE(s) or based on an absence of PSFCH receptions.

In the context of the present disclosure, HARQ-ACK feedback or information transmitted on a PSFCH is also referred to as sidelink HARQ-ACK feedback or information, and HARQ-ACK feedback or information transmitted on a PUCCH is also referred to as UL HARQ-ACK feedback or information. In addition, a PSFCH occasion may refer to a PSFCH transmission occasion from the perspective of an Rx UE and a PSFCH reception occasion from the perspective of a Tx UE. A PUCCH occasion may refer to a PUCCH transmission occasion from the perspective of a UE and a PUCCH reception occasion from the perspective of a BS.

In some embodiments of the present disclosure, sidelink transmission may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum. When the LBT test is successful, a Tx UE can transmit a sidelink transmission (e.g., PSSCH) to an Rx UE and may wait for the reception of a PSFCH from the Rx UE. Otherwise, if the LBT test fails, the Tx UE cannot start any transmission on the channel, and may generate a NACK and transmit it in a PUCCH to the BS so that the BS can schedule resources for the retransmission of the PSSCH.

Similarly, an Rx UE may need to perform an LBT test before transmitting the PSFCH to the Tx UE on an unlicensed spectrum. However, if the LBT test at the Rx UE side fails, the Rx UE cannot transmit the PSFCH to the Tx UE even though the Rx UE has successfully decoded the PSSCH. If the Tx UE generates a NACK based on the absence of a PSFCH reception and transmits it in a PUCCH to the BS, the BS has to schedule resources for the retransmission of the PSSCH. Resource allocation for an unnecessary retransmission would lead to performance degradation. Solutions that can avoid such performance degradation due to an LBT failure are desired.

In some embodiments of the present disclosure, sidelink HARQ-ACK feedback for a single PSSCH on an unlicensed carrier can have more than one PSFCH transmission occasion (e.g., up to 4 PSFCH transmission occasions) or, from the perspective of the Tx UE, more than one PSFCH reception occasion (e.g., up to 4 PSFCH reception occasions). If an Rx UE cannot transmit a PSFCH in a certain PSFCH occasion, it may have an additional opportunity to transmit the PSFCH in additional PSFCH occasions, if any. From a Tx UE's perspective, if it does not detect a PSFCH in a certain PSFCH occasion, there may be additional PSFCH occasions for this PSFCH later. In this scenario, solutions to generate an appropriate (e.g., accurate) UL HARQ-ACK information for the current PUCCH transmission occasion are desired.

In some embodiments of the present disclosure, a new state (hereinafter, “pending”) besides “ACK” and “NACK” is introduced to indicate the UL HARQ-ACK information.

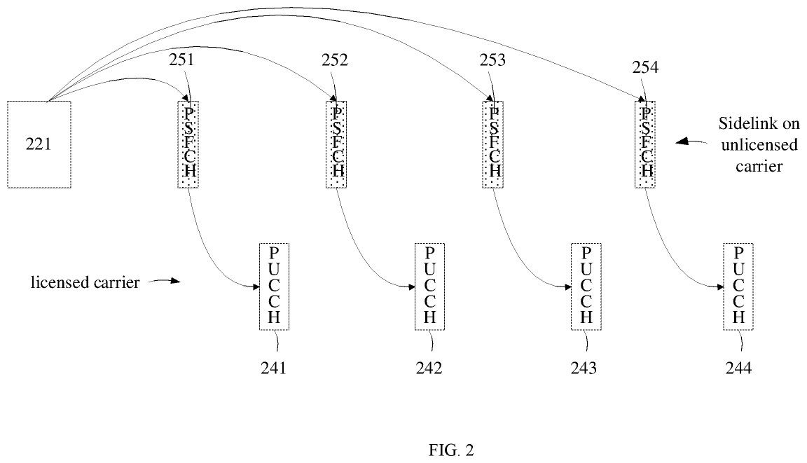

For example, referring to FIG. 2, 4 candidate PSFCH transmission occasions 251-254 are configured for PSSCH 221 scheduled by a DCI format, and there are 4 PUCCH transmission occasions 241-244 corresponding to the 4 candidate PSFCH transmission occasions. If the Tx UE does not detect a PSFCH for PSSCH 221 in PSFCH candidate transmission occasion 251, for each of cast type (e.g., unicast transmission, groupcast transmission with ACK/NACK feedback or groupcast transmission with NACK-only feedback), the Tx UE cannot determine the UL HARQ-ACK information (i.e., ACK or NACK) due to a possible LBT failure at the Rx UE(s) for transmitting the PSFCH. Hence, it does not make sense to report ACK or NACK in the PUCCH transmission occasion 241 followed immediately after PSFCH transmission occasion 251. Since there are additional PSFCH transmission occasions and additional PUCCH transmission occasions after PUCCH transmission occasion 241, the Tx UE may report the “pending” state to inform the BS that the sidelink HARQ-ACK feedback for PSSCH 221 will be reported in the UL HARQ-ACK information in a later PUCCH transmission occasion.

Embodiments of the present disclosure provide solutions to solve the above UL HARQ-ACK information generation issue. For example, serval UL HARQ-ACK information generation procedures are provided. The UL HARQ-ACK information can indicate a “pending”, “ACK” or “NACK” state. In addition, solutions for transmitting a PUCCH carrying the UL HARQ-ACK information are also provided. More details on the embodiments of the present disclosure will be illustrated in the following text in combination with the appended drawings.

Embodiments of the present disclosure are discussed in the scenario where resource allocation mode 1 is adopted for a sidelink transmission and HARQ-ACK feedback for a single sidelink transmission over an unlicensed spectrum can be configured or preconfigured, or predefined to have multiple PSFCH reception opportunities (e.g., multiple PSFCH reception occasions).

In this scenario, a UE (e.g., Tx UE) may receive a DCI format for scheduling a resource or activating a configured grant for transmitting a PSSCH (e.g., M PSSCHs). In some embodiments, the Tx UE may not transmit the PSSCH due to, for example, an LBT failure at the Tx UE. As will be described in more detail later, the Tx UE may determine corresponding UL HARQ-ACK information to indicate the failure to transmit the PSSCH. In some embodiments, the Tx UE may transmit the PSSCH (e.g., M PSSCHs) to another UE (e.g., at least one Rx UE) based on the DCI format. The PSSCH (e.g., M PSSCHs) can be associated with a unicast transmission, a groupcast transmission with ACK/NACK feedback or a groupcast transmission with NACK-only feedback. M can be equal to or greater than 1. The sidelink HARQ-ACK feedback for the PSSCH can be generated by an Rx UE after the last PSSCH of the M PSSCHs and can be transmitted by the Rx UE in a plurality of candidate PSFCH transmission occasions (e.g., N candidate PSFCH transmission occasions). The sidelink HARQ-ACK feedback for the PSSCH may refer to the sidelink HARQ-ACK feedback for all of the M PSSCHs. In some embodiment, the M PSSCHs may carry the same transport block (TB) and the sidelink HARQ-ACK feedback for the PSSCH may refer to the sidelink HARQ-ACK feedback for the TB.

The Tx UE may detect the sidelink HARQ-ACK feedback for the PSSCH in one or more of the plurality of candidate PSFCH transmission occasions. For example, the Rx UE may transmit the sidelink HARQ-ACK feedback for the PSSCH (i.e., carried in a PSFCH) to the Tx UE in the earliest candidate PSFCH transmission occasion of the N candidate PSFCH transmission occasions with an LBT success. The Tx UE thus can detect the sidelink HARQ-ACK feedback for the PSSCH in this candidate PSFCH transmission occasion. However, due to, for example, an LBT failure at the Rx UE side, the Rx UE cannot transmit the sidelink HARQ-ACK feedback for the PSSCH in a certain candidate PSFCH transmission occasion, and thus the Tx UE cannot detect the sidelink HARQ-ACK feedback in this candidate PSFCH transmission occasion.

It is assumed that there are K PUCCH transmission occasions corresponding to the N candidate PSFCH transmission occasions for the Tx UE to report UL HARQ-ACK information in a PUCCH to the BS, where, for example, 1<=K<=N. The value of K and the resources for the PUCCH transmission occasions can be explicit or implicitly configured, preconfigured, or predefined. Then, for each of the K PUCCH transmission occasions, the Tx UE may determine or generate corresponding UL HARQ-ACK information corresponding to the PSSCH based on the sidelink HARQ-ACK feedback detected by the Tx UE or an absence of the sidelink HARQ-ACK feedback in one or more of the plurality of candidate PSFCH transmission occasions before the current PUCCH transmission occasion.

In some embodiments of the present disclosure, the UL HARQ-ACK information may indicate one of the following three states: “ACK,” “NACK,” and “pending,” depending on the PSFCH detections within all the candidate PSFCH transmission occasions for the PSSCH before the current PUCCH transmission occasion. The “ACK” state indicates an acknowledgement corresponding to the PSSCH, suggesting that the Rx UE (or all the Rx UEs) has correctly decoded the PSSCH. The “NACK” state indicates a negative acknowledgement corresponding to the PSSCH suggesting that either the Rx UE (or at least one Rx UE) has failed to decode the PSSCH or the Tx UE has failed to transmit the PSSCH due to, for example, an LBT failure at the Tx UE before transmitting the PSSCH.

The “pending” state suggests that the Tx UE cannot yet determine whether the Rx UE has correctly decoded the PSSCH or not. For example, the “pending” state may indicate that the sidelink HARQ-ACK feedback for the PSSCH is to be reported in a later PUCCH transmission occasion of the K PUCCH transmission occasions. For example, the “pending” state may indicate that the sidelink HARQ-ACK feedback for the PSSCH is pending in the current PUCCH transmission occasion. For example, the “pending” state may indicate that the sidelink HARQ-ACK feedback is not obtained in the candidate PSFCH transmission occasion(s) before the current PUCCH transmission occasion in the plurality of candidate PSFCH transmission occasions and will be reported in a later PUCCH transmission occasion of the K PUCCH transmission occasions.

Persons skilled in the art would appreciate that other names may be used to represent the above three states.

Various methods may be employed for determining the UL HARQ-ACK information corresponding to the PSSCH based on the sidelink HARQ-ACK feedback or the absence of the sidelink HARQ-ACK feedback.

In some embodiments of the present disclosure, the UL HARQ-ACK information corresponding to the PSSCH may be determined as “pending” under certain conditions.

For example, in some embodiments, the PSSCH is associated with a unicast transmission. That is, the PSSCH is transmitted from the Tx UE to a single Rx UE. In response to that the Tx UE does not detect any sidelink HARQ-ACK feedback for the PSSCH before the current PUCCH transmission occasion, and that the plurality of candidate PSFCH transmission occasions includes at least one candidate PSFCH transmission occasion after the current PUCCH transmission occasion, the Tx UE may determine the UL HARQ-ACK information corresponding to the PSSCH as “pending.”

Persons skilled in the art would appreciate that the last PUCCH transmission occasion should be located after the candidate PSFCH transmission occasion in the time domain and thus “at least one candidate PSFCH transmission occasion after the current PUCCH transmission occasion” in the context of the present disclosure means that there is an additional PUCCH transmission occasion within the K PUCCH transmission occasions after the current PUCCH transmission occasion.

For example, in some embodiments, the PSSCH is associated with a groupcast transmission with UE-specific ACK/NACK feedback. That is, the PSSCH is transmitted from the Tx UE to a group of Rx UEs which should transmit UE-specific ACK or NACK to the Tx UE for the PSSCH. In response to that the Tx UE does not receive a NACK from any UE in the group of UEs in any PSFCH transmission occasion before the current PUCCH transmission occasion among the plurality of candidate PSFCH transmission occasions, and that the plurality of candidate PSFCH transmission occasions includes at least one candidate PSFCH transmission occasion after the current PUCCH transmission occasion, the Tx UE may determine the UL HARQ-ACK information corresponding to the PSSCH as “pending.” In the case of a groupcast transmission with UE-specific ACK/NACK feedback, a Tx UE may receive an ACK or a NACK from an Rx UE in the UE group on a PSFCH resource corresponding to the member identity (denoted as M_{ID}) of this Rx UE in a certain candidate PSFCH transmission occasion.

For example, in some embodiments, the PSSCH is associated with a groupcast transmission with NACK-only based feedback. That is, the PSSCH is transmitted from the Tx UE to a group of Rx UEs, and a member Rx UE does not transmit an ACK if it correctly decodes the PSSCH, but should transmit a NACK to the Tx UE if it fails to decode or receive the PSSCH. In response to that the Tx UE does not receive a NACK in any PSFCH transmission occasion before the current PUCCH transmission occasion among the plurality of candidate PSFCH transmission occasions, and that the plurality of candidate PSFCH transmission occasions includes at least one candidate PSFCH transmission occasion after the current PUCCH transmission occasion, the Tx UE may determine the UL HARQ-ACK information corresponding to the PSSCH as “pending.”

In some embodiments of the present disclosure, the UL HARQ-ACK information corresponding to the PSSCH may be determined as “ACK” under certain conditions.

For example, in some embodiments, the PSSCH is associated with a groupcast transmission with UE-specific ACK/NACK feedback to a group of UEs. In response to that the Tx UE receives ACKs from all UEs in the group of UEs in the plurality of candidate PSFCH transmission occasions (e.g., in candidate PSFCH transmission occasions before the current PSFCH transmission occasion), the Tx UE may determine the UL HARQ-ACK information corresponding to the PSSCH as “ACK.” In some examples, after the last candidate PSFCH transmission occasion of the plurality of candidate PSFCH transmission occasions, the Tx UE may determine the UL HARQ-ACK information corresponding to the PSSCH as “ACK” if it receives ACKs from all UEs in the group of UEs.

For example, in some embodiments, the PSSCH is associated with a groupcast transmission with NACK-only based feedback to a group of UEs. In response to that the Tx UE does not receive a NACK in all of the plurality of candidate PSFCH transmission occasions, and that the plurality of candidate PSFCH transmission occasions does not include a candidate PSFCH transmission occasion after the current PUCCH transmission occasion, the Tx UE may determine the UL HARQ-ACK information corresponding to the PSSCH as “ACK.” In other words, after the last candidate PSFCH transmission occasion corresponding of the plurality of candidate PSFCH transmission occasions, the Tx UE may determine the UL HARQ-ACK information corresponding to the PSSCH as “ACK” if it does not receive a NACK from all of the plurality of candidate PSFCH transmission occasions.

In some embodiments of the present disclosure, the UL HARQ-ACK information corresponding to the PSSCH may be determined as “NACK” under certain conditions.

For example, in some embodiments, the PSSCH is associated with a unicast transmission. In response to that the Tx UE does not detect any sidelink HARQ-ACK feedback for the PSSCH before the current PUCCH transmission occasion, and that the plurality of candidate PSFCH transmission occasions does not include a candidate PSFCH transmission occasion after the current PUCCH transmission occasion, the Tx UE may determine the UL HARQ-ACK information corresponding to the PSSCH as “NACK.” In other words, the Tx UE may determine the UL HARQ-ACK information corresponding to the PSSCH as “NACK” if it does not detect any PSFCH for the PSSCH within all the candidate PSFCH transmission occasions.

For example, in some embodiments, the PSSCH is associated with a groupcast transmission with UE-specific ACK/NACK feedback to a group of UEs. In response to that the Tx UE receives a NACK from any UE in the group of UEs in any PSFCH transmission occasion before the current PUCCH transmission occasion among the plurality of candidate PSFCH transmission occasions, the Tx UE may determine the UL HARQ-ACK information corresponding to the PSSCH as “NACK.”

For example, in some embodiments, the PSSCH is associated with a groupcast transmission with UE-specific ACK/NACK feedback to a group of UEs. In response to that the Tx UE does not receive ACKs from all UEs in the group of UEs in the plurality of candidate PSFCH transmission occasions, and that the plurality of candidate PSFCH transmission occasions does not include a candidate PSFCH transmission occasion after the current PUCCH transmission occasion, the Tx UE may determine the UL HARQ-ACK information corresponding to the PSSCH as “NACK.” In other words, after the last candidate PSFCH transmission occasion of the plurality of candidate PSFCH transmission occasions, the Tx UE may determine the UL HARQ-ACK information corresponding to the PSSCH as “NACK” if the Tx UE does not receive ACKs from all UEs in the group of UEs.

For example, in some embodiments, the PSSCH is associated with a groupcast transmission with NACK-only based feedback to a group of UEs. In response to that the Tx UE receives at least one NACK in any PSFCH transmission occasion before the current PUCCH transmission occasion among the plurality of candidate PSFCH transmission occasions, the Tx UE may determine the UL HARQ-ACK information corresponding to the PSSCH as “NACK.”

For example, in some embodiments, a channel access procedure before the transmission of the PSSCH may be required at the Tx UE. In response to the channel access procedure for transmitting the PSSCH is failed at the Tx UE, the Tx UE may not transmit the PSSCH on the resource(s) assigned or activated by DCI format and determine the UL HARQ-ACK information corresponding to the PSSCH as “NACK.”

In some embodiments of the present disclosure, the UL HARQ-ACK information corresponding to the PSSCH may determine as the same as the sidelink HARQ-ACK feedback for the PSSCH (e.g., ACK or NACK) under certain conditions.

For example, in some embodiments, the PSSCH is associated with a unicast transmission. In response to that the Tx UE detects the sidelink HARQ-ACK feedback for the PSSCH in any candidate PSFCH transmission occasion before the current PUCCH transmission occasion among the plurality of candidate PSFCH transmission occasions, the Tx UE may determine the UL HARQ-ACK information corresponding to the PSSCH as the same as the sidelink HARQ-ACK feedback for the PSSCH. That is, if the detected sidelink HARQ-ACK feedback is an ACK, the UL HARQ-ACK information is an ACK, i.e., indicates an “ACK” state. If the detected sidelink HARQ-ACK feedback is a NACK, the UL HARQ-ACK information is a NACK, i.e., indicates a “NACK” state. Whether there is an additional PSFCH transmission occasion of the plurality of candidate PSFCH transmission occasions after the current PUCCH transmission occasion would not be taken into account when determining the UL HARQ-ACK information.

In some embodiments of the present disclosure, at least two bits are required for reporting the UL HARQ-ACK information indicating one of the three states as described above, i.e., {ACK, NACK, pending}. The Tx UE may transmit the UL HARQ-ACK information to the BS in the corresponding PUCCH transmission occasion. An exemplary mapping between the UL HARQ-ACK information bits and the three states is shown in Table 1 below.

TABLE 1
mapping HARQ-ACK information bits to states

| HARQ-ACK information bits | State |
|---|---|
| 00 | Reserved |
| 01 | Pending |
| 10 | NACK |
| 11 | ACK |

After determining the UL HARQ-ACK information according to the methods as described above, the Tx UE can perform a PUCCH transmission, and the BS can perform PUCCH detection and reception. The specific UE behaviors and BS behaviors are described below.

In some embodiments, the Tx UE may transmit a PUCCH (i.e., UL HARQ-ACK information corresponding to the PSSCH) on each of the K PUCCH transmission occasions. If the Tx UE reports UL HARQ-ACK information indicating “pending,” it will report UL HARQ-ACK information indicating “ACK” or “NACK” in a subsequent PUCCH transmission occasion(s). If the Tx UE reports UL HARQ-ACK information indicating “ACK” or “NACK” in a certain PUCCH transmission occasion, it will repeat the same UL HARQ-ACK information in the subsequent PUCCH transmission occasion(s).

The BS may detect a PUCCH (e.g., UL HARQ-ACK information) from the Tx UE in each of the K PUCCH occasions. The BS may determine to schedule resource for retransmission of the PSSCH transmission if the BS detects a “NACK” in any of the PUCCH occasions. If the BS detects “pending” in a PUCCH occasion, then the BS may continue the PUCCH detection and will detect UL HARQ-ACK information indicating “ACK” or “NACK” in a subsequent PUCCH occasion(s).

In some embodiments, the Tx UE may transmit UL HARQ-ACK information indicating “ACK” or “NACK” in a certain PUCCH transmission occasion (denoted as occasion #1) of the K PUCCH transmission occasions and not transmit the HARQ-ACK information in the subsequent PUCCH transmission occasion(s) after occasion #1 in the K PUCCH transmission occasions. The Tx UE may transmit correspondingly determined UL HARQ-ACK information in the PUCCH transmission occasion(s) before occasion #1 in the K PUCCH transmission occasions. For example, the Tx UE may report UL HARQ-ACK information indicating “pending” in one or more PUCCH transmission occasions until it reports UL HARQ-ACK information indicating “ACK” or “NACK” in occasion #1. Then, the Tx UE may not transmit UL HARQ-ACK information in the subsequent PUCCH transmission occasion(s).

The BS may detect a PUCCH (e.g., UL HARQ-ACK information) from the Tx UE from the earliest PUCCH occasion of the K PUCCH occasions until an “ACK” or a “NACK” is detected (or received) by the BS in one (e.g., occasion #1) of the K PUCCH occasions. The BS may determine to schedule resource for retransmission of the PSSCH transmission if the BS detects a “NACK” in this PUCCH occasion. The BS may ignore the subsequent PUCCH occasion(s) of the K PUCCH occasions. If the BS detects “pending” in a PUCCH occasion, then the BS may continue the PUCCH detection until detecting UL HARQ-ACK information indicating “ACK” or “NACK” in a subsequent PUCCH occasion.

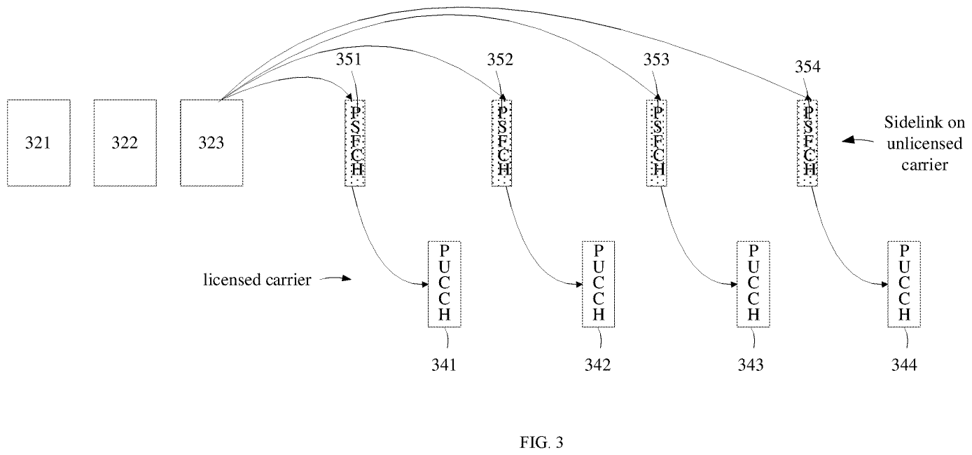

For example, in FIG. 3, it is assumed that the sidelink HARQ-ACK feedback for one PSSCH has 4 candidate PSFCH transmission occasions and there are 4 PUCCH transmission occasions corresponding to the 4 candidate PSFCH transmission occasions

Referring to FIG. 3, a DCI format may schedule PSSCHs 321-323. The earliest candidate PSFCH transmission occasion (i.e., candidate PSFCH transmission occasion 351) of the 4 candidate PSFCH transmission occasions 351-354 is after the last PSSCH (i.e., PSSCH 323) scheduled by the DCI format. Each of PUCCH transmission occasions 341-344 corresponds to one of candidate PSFCH transmission occasions 351-354.

If the Tx UE does not detect any PSFCH in PSFCH candidate transmission occasion 351, the Tx UE may report “pending” in PUCCH transmission occasion 341 and may generate “ACK” or “NACK” and report it in a subsequent PUCCH transmission occasion(s). For example, the Tx UE may report “pending” in PUCCH transmission occasion 342 and may report “ACK” in PUCCH transmission occasion 343. In some embodiments, the Tx UE may report “ACK” in PUCCH transmission occasion 344. In some other embodiments, the Tx UE may not transmit a PUCCH in PUCCH transmission occasion 344.

In some embodiments of the present disclosure, at least one bit is required for reporting the UL HARQ-ACK information indicating one of the three states as described above, i.e., {ACK, NACK, pending}. In the case that the UL HARQ-ACK information is determined as “ACK” or “NACK,” the Tx UE may transmit the determined UL HARQ-ACK information. In the case that the UL HARQ-ACK information is determined as “pending,” a specific UE behavior is used to indicate the “pending” state. For example, the Tx UE may not transmit UL HARQ-ACK information in the current PUCCH transmission occasion or skip the PUCCH transmission in the current PUCCH transmission occasion. Accordingly, without detecting a PUCCH in a PUCCH reception occasion, the BS may determine that the UL HARQ-ACK information indicates the “pending” state, e.g., not yet available at the Tx UE and will be transmitted in a later PUCCH transmission occasion.

After determining the UL HARQ-ACK information according to the methods as described above, the Tx UE can perform a PUCCH transmission, and the BS can perform PUCCH detection and reception. The specific UE behaviors and BS behaviors are described below.

In some embodiments, the Tx UE may determine UL HARQ-ACK information as “pending” for a PUCCH transmission occasion and then not transmit a PUCCH in this PUCCH transmission occasion for indicating the “pending” state. The Tx UE will report UL HARQ-ACK information indicating “ACK” or “NACK” in a subsequent PUCCH transmission occasion(s). For example, if the Tx UE reports UL HARQ-ACK information indicating “ACK” or “NACK” in a certain PUCCH transmission occasion (denoted as occasion #2), it will repeat the same UL HARQ-ACK information in the subsequent PUCCH transmission occasion(s).

In other words, the Tx UE may transmit UL HARQ-ACK information indicating “ACK” or “NACK” in occasion #2 of the K PUCCH transmission occasions and the subsequent PUCCH transmission occasion(s) after the occasion #2 in the K PUCCH transmission occasions. The Tx UE may not transmit any UL HARQ-ACK information in each PUCCH transmission occasion before occasion #2 in the K PUCCH transmission occasions.

The BS may detect a PUCCH (e.g., UL HARQ-ACK information) from the Tx UE in each of the K PUCCH occasions. The BS may determine to schedule resource for retransmission of the PSSCH transmission if the BS detects a “NACK” in any of the PUCCH occasions. If the BS does not detect a PUCCH in a PUCCH occasion, then the BS assumes that “pending” is reported by the Tx UE. The BS may continue the PUCCH detection and will detect UL HARQ-ACK information indicating “ACK” or “NACK” in a subsequent PUCCH occasion(s).

In some embodiments, the Tx UE may determine UL HARQ-ACK information as “pending” for a PUCCH transmission occasion and then not transmit a PUCCH in this PUCCH transmission occasion for indicating the “pending” state. The Tx UE may transmit UL HARQ-ACK information indicating “ACK” or “NACK” in a certain PUCCH transmission occasion (denoted as occasion #3) of the K PUCCH transmission occasions and not transmit the HARQ-ACK information in the subsequent PUCCH transmission occasion(s) after occasion #3 in the K PUCCH transmission occasions. For example, the Tx UE may report UL HARQ-ACK information indicating “ACK” or “NACK” in occasion #3. The Tx UE may not transmit UL HARQ-ACK information in the PUCCH transmission occasion(s) before and after occasion #3 in the K PUCCH transmission occasions.

The BS may detect a PUCCH (e.g., UL HARQ-ACK information) from the Tx UE from the earliest PUCCH occasion of the K PUCCH occasions until an “ACK” or a “NACK” is detected (or received) by the BS in one (e.g., occasion #3) of the K PUCCH occasions. The BS may determine to schedule resource for retransmission of the PSSCH transmission if the BS detects a “NACK” in this PUCCH occasion. The BS may ignore the subsequent PUCCH occasion(s) of the K PUCCH occasions. If the BS does not detect a PUCCH in a PUCCH occasion, then the BS assumes that “pending” is reported by the Tx UE. Then the BS may continue the PUCCH detection until detecting UL HARQ-ACK information indicating “ACK” or “NACK” in a subsequent PUCCH occasion (e.g., occasion #3).

For example, referring again to FIG. 3, if the Tx UE does not detect any PSFCH in PSFCH candidate transmission occasion 351, the Tx UE may not transmit a PUCCH in PUCCH transmission occasion 341 to indicating the “pending” state. The Tx UE may generate “ACK” or “NACK” and report it in a subsequent PUCCH transmission occasion(s). For example, the Tx UE may not transmit a PUCCH in PUCCH transmission occasion 342 and may report “ACK” in PUCCH transmission occasion 343. In some embodiments, the Tx UE may report “ACK” in PUCCH transmission occasion 344. In some other embodiments, the Tx UE may not transmit a PUCCH in PUCCH transmission occasion 344.

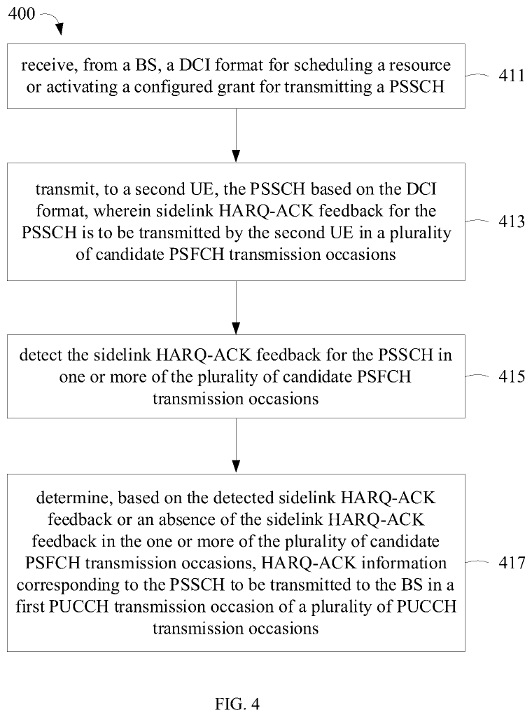

FIG. 4 illustrates a flowchart of method 400 for wireless communication in accordance with some embodiments of the present disclosure. Details described in all of the foregoing embodiments of the present disclosure are applicable for the embodiments shown in FIG. 4. In some examples, method 400 may be performed by a UE, for example, UE 104 as described with reference to FIG. 1. In some embodiments, the UE may execute a set of instructions to control the functional elements of the UE to perform the described functions or operations. In some examples, a processor of a UE may cause the UE to perform method 400.

At 411, a first UE may receive, from a BS, a DCI format for scheduling a resource or activating a configured grant for transmitting a PSSCH. At 413, the first UE may transmit, to a second UE, the PSSCH based on the DCI format, wherein sidelink HARQ-ACK feedback for the PSSCH is to be transmitted by the second UE in a plurality of candidate PSFCH transmission occasions. At 415, the first UE may detect the sidelink HARQ-ACK feedback for the PSSCH in one or more of the plurality of candidate PSFCH transmission occasions.

At 417, the first UE may determine, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first PUCCH transmission occasion of a plurality of PUCCH transmission occasions. Various methods for determining the UL HARQ-ACK information as described above may apply here.

In some embodiments, the HARQ-ACK information corresponding to the PSSCH indicates one of the following three states: a first state indicating an ACK corresponding to the PSSCH; a second state indicating a NACK corresponding to the PSSCH; and a third state indicating one of the following: the sidelink HARQ-ACK feedback for the PSSCH is to be reported in a later PUCCH transmission occasion of the plurality of PUCCH transmission occasions; the sidelink HARQ-ACK feedback is pending in the first PUCCH transmission occasion; and the sidelink HARQ-ACK feedback is not obtained in a candidate PSFCH transmission occasion(s) before the first PUCCH transmission occasion in the plurality of candidate PSFCH transmission occasions and will be reported in a later PUCCH transmission occasion of the plurality of PUCCH transmission occasions.

In some embodiments, the HARQ-ACK information corresponding to the PSSCH is determined as the third state in response to one of the following: the PSSCH is associated with a unicast transmission, the first UE does not detect any sidelink HARQ-ACK feedback for the PSSCH before the first PUCCH transmission occasion and the plurality of candidate PSFCH transmission occasions includes at least one candidate PSFCH transmission occasion after the first PUCCH transmission occasion; the PSSCH is associated with a groupcast transmission with UE-specific ACK/NACK feedback to a group of UEs including the second UE, the plurality of candidate PSFCH transmission occasions includes at least one candidate PSFCH transmission occasion after the first PUCCH transmission occasion and the first UE does not receive a NACK from any UE in the group of UEs in any PSFCH transmission occasion before the first PUCCH transmission occasion among the plurality of candidate PSFCH transmission occasions; and the PSSCH is associated with a groupcast transmission with NACK-only based feedback to a group of UEs including the second UE, the plurality of candidate PSFCH transmission occasions includes at least one candidate PSFCH transmission occasion after the first PUCCH transmission occasion and the first UE does not receive a NACK in any PSFCH transmission occasion before the first PUCCH transmission occasion among the plurality of candidate PSFCH transmission occasions.

In some embodiments, the HARQ-ACK information corresponding to the PSSCH is determined as the first state in response to one of the following: the PSSCH is associated with a groupcast transmission with UE-specific ACK/NACK feedback to a group of UEs including the second UE and the first UE receives ACKs from all UEs in the group of UEs in the plurality of candidate PSFCH transmission occasions; and the PSSCH is associated with a groupcast transmission with NACK-only based feedback to a group of UEs including the second UE, the plurality of candidate PSFCH transmission occasions does not include a candidate PSFCH transmission occasion after the first PUCCH transmission occasion, and the first UE does not receive a NACK in all of the plurality of candidate PSFCH transmission occasions.

In some embodiments, the HARQ-ACK information corresponding to the PSSCH is determined as the second state in response to one of the following: the PSSCH is associated with a unicast transmission, the first UE does not detect any sidelink HARQ-ACK feedback for the PSSCH before the first PUCCH transmission occasion and the plurality of candidate PSFCH transmission occasions does not include a candidate PSFCH transmission occasion after the first PUCCH transmission occasion; the PSSCH is associated with a groupcast transmission with UE-specific ACK/NACK feedback to a group of UEs including the second UE and the first UE receives a NACK from any UE in the group of UEs in any PSFCH transmission occasion before the first PUCCH transmission occasion among the plurality of candidate PSFCH transmission occasions; the PSSCH is associated with a groupcast transmission with UE-specific ACK/NACK feedback to a group of UEs including the second UE, the plurality of candidate PSFCH transmission occasions does not include a candidate PSFCH transmission occasion after the first PUCCH transmission occasion, and the first UE does not receive ACKs from all UEs in the group of UEs in the plurality of candidate PSFCH transmission occasions; the PSSCH is associated with a groupcast transmission with NACK-only based feedback to a group of UEs including the second UE and the first UE receives at least one NACK in any PSFCH transmission occasion before the first PUCCH transmission occasion among the plurality of candidate PSFCH transmission occasions; and a channel access procedure before the transmission of the PSSCH is failed at the first UE and the first UE does not transmit the PSSCH.

In some embodiments, to determine the HARQ-ACK information corresponding to the PSSCH, the first UE may determine that the HARQ-ACK information corresponding to the PSSCH is the same as the sidelink HARQ-ACK feedback for the PSSCH in response to the PSSCH being associated with a unicast transmission and the sidelink HARQ-ACK feedback for the PSSCH being detected in any candidate PSFCH transmission occasion before the first PUCCH transmission occasion among the plurality of candidate PSFCH transmission occasions.

In some embodiments, the HARQ-ACK information corresponding to the PSSCH includes at least two bits to indicate the first, second or third state. The first UE may transmit the HARQ-ACK information corresponding to the PSSCH to the BS in the first PUCCH transmission occasion.

In some embodiments, the HARQ-ACK information corresponding to the PSSCH includes at least one bit to indicate the first state or the second state. In the case that the HARQ-ACK information corresponding to the PSSCH is determined as the third state, the first UE may not transmit the HARQ-ACK information in the first PUCCH transmission occasion.

In some embodiments, the first UE may transmit the HARQ-ACK information corresponding to the PSSCH in each of the plurality of PUCCH transmission occasions. In some embodiments, the first UE may transmit the HARQ-ACK information indicating an ACK or a NACK corresponding to the PSSCH in the first PUCCH transmission occasion of the plurality of PUCCH transmission occasions and not transmit the HARQ-ACK information in the subsequent PUCCH transmission occasion(s) after the first PUCCH transmission occasion in the plurality of PUCCH transmission occasions.

In some embodiments, the first UE may transmit the HARQ-ACK information indicating an ACK or a NACK corresponding to the PSSCH in the first PUCCH transmission occasion of the plurality of PUCCH transmission occasions and the subsequent PUCCH transmission occasion(s) after the first PUCCH transmission occasion in the plurality of PUCCH transmission occasions and not transmit the HARQ-ACK information corresponding to the PSSCH in each PUCCH transmission occasion before the first PUCCH transmission occasion in the plurality of PUCCH transmission occasions. In some embodiments, the first UE may transmit the HARQ-ACK information indicating an ACK or a NACK corresponding to the PSSCH in the first PUCCH transmission occasion and not transmit the HARQ-ACK information in all subsequent PUCCH transmission occasions in the plurality of PUCCH transmission occasions.

It should be appreciated by persons skilled in the art that the sequence of the operations in exemplary method 400 may be changed and some of the operations in exemplary method 400 may be eliminated or modified, without departing from the spirit and scope of the disclosure.

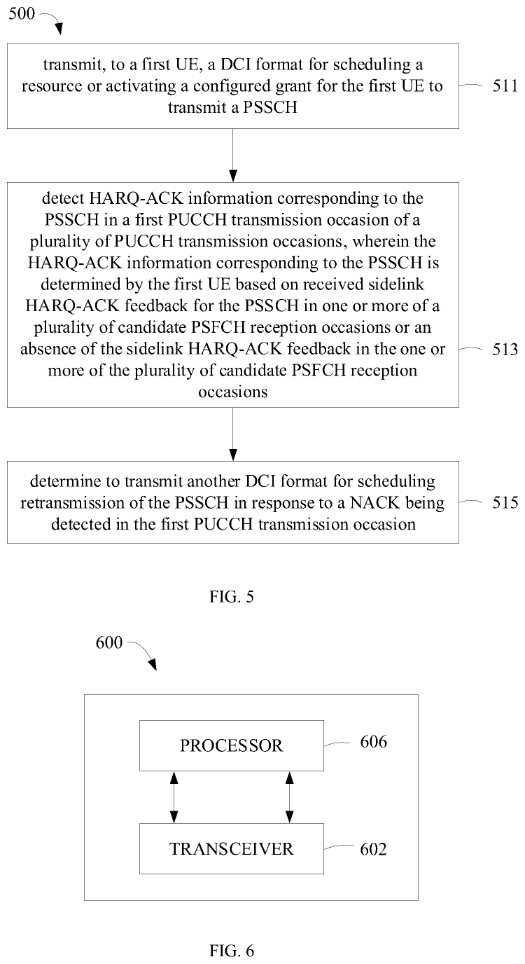

FIG. 5 illustrates a flowchart of method 500 for wireless communication in accordance with some embodiments of the present disclosure. Details described in all of the foregoing embodiments of the present disclosure are applicable for the embodiments shown in FIG. 5. In some examples, method 500 may be performed by a BS or an NE (for example, NE 105 as described with reference to FIG. 1). In some embodiments, the BS or the NE may execute a set of instructions to control the functional elements of the BS or the NE to perform the described functions or operations. In some examples, a processor of an NE may cause the NE to perform method 500.

At 511, a BS may transmit, to a first UE, a DCI format for scheduling a resource or activating a configured grant for the first UE to transmit a PSSCH. At 513, the BS may detect HARQ-ACK information corresponding to the PSSCH in a first PUCCH transmission occasion of a plurality of PUCCH transmission occasions. The HARQ-ACK information corresponding to the PSSCH is determined by the first UE based on received sidelink HARQ-ACK feedback for the PSSCH in one or more of a plurality of candidate PSFCH reception occasions or an absence of the sidelink HARQ-ACK feedback in the one or more of the plurality of candidate PSFCH reception occasions. Various methods for determining the UL HARQ-ACK information as described above may apply here.

At 515, the BS may determine to transmit another DCI format for scheduling retransmission of the PSSCH in response to a NACK being detected in the first PUCCH transmission occasion.

In some embodiments, the HARQ-ACK information corresponding to the PSSCH indicates one of the following three states: a first state indicating an ACK corresponding to the PSSCH; a second state indicating a NACK corresponding to the PSSCH; and a third state indicating one of the following: the sidelink HARQ-ACK feedback for the PSSCH is to be reported by the first UE in a later PUCCH transmission occasion of the plurality of PUCCH transmission occasions; the sidelink HARQ-ACK feedback is pending in the first PUCCH transmission occasion; and the sidelink HARQ-ACK feedback is not obtained by the first UE in a candidate PSFCH reception occasion(s) before the first PUCCH transmission occasion in the plurality of candidate PSFCH reception occasions and will be reported by the first UE in a later PUCCH transmission occasion of the plurality of PUCCH transmission occasions.

In some embodiments, the HARQ-ACK information corresponding to the PSSCH indicates the third state in response to one of the following: the PSSCH is associated with a unicast transmission, the first UE does not detect any sidelink HARQ-ACK feedback for the PSSCH before the first PUCCH transmission occasion and the plurality of candidate PSFCH reception occasions includes at least one candidate PSFCH reception occasion after the first PUCCH transmission occasion; the PSSCH is associated with a groupcast transmission with UE-specific ACK/NACK feedback to a group of UEs, the plurality of candidate PSFCH reception occasions includes at least one candidate PSFCH reception occasion after the first PUCCH transmission occasion and the first UE does not receive a NACK from any UE in the group of UEs in any PSFCH reception occasion before the first PUCCH transmission occasion among the plurality of candidate PSFCH reception occasions; and the PSSCH is associated with a groupcast transmission with NACK-only based feedback to a group of UEs, the plurality of candidate PSFCH reception occasions includes at least one candidate PSFCH reception occasion after the first PUCCH transmission occasion and the first UE does not receive a NACK in any PSFCH reception occasion before the first PUCCH transmission occasion among the plurality of candidate PSFCH reception occasions.

In some embodiments, the HARQ-ACK information corresponding to the PSSCH indicates the first state in response to one of the following: the PSSCH is associated with a groupcast transmission with UE-specific ACK/NACK feedback to a group of UEs and the first UE receives ACKs from all UEs in the group of UEs in the plurality of candidate PSFCH reception occasions; and the PSSCH is associated with a groupcast transmission with NACK-only based feedback to a group of UEs, the plurality of candidate PSFCH reception occasions does not include a candidate PSFCH reception occasion after the first PUCCH transmission occasion, and the first UE does not receive a NACK in all of the plurality of candidate PSFCH reception occasions.

In some embodiments, the HARQ-ACK information corresponding to the PSSCH indicates the second state in response to one of the following: the PSSCH is associated with a unicast transmission, the first UE does not detect any sidelink HARQ-ACK feedback for the PSSCH before the first PUCCH transmission occasion and the plurality of candidate PSFCH reception occasions does not include a candidate PSFCH reception occasion after the first PUCCH transmission occasion; the PSSCH is associated with a groupcast transmission with UE-specific ACK/NACK feedback to a group of UEs and the first UE receives a NACK from any UE in the group of UEs in any PSFCH reception occasion before the first PUCCH transmission occasion among the plurality of candidate PSFCH reception occasions; the PSSCH is associated with a groupcast transmission with UE-specific ACK/NACK feedback to the group of UEs, the plurality of candidate PSFCH reception occasions does not include a candidate PSFCH reception occasion after the first PUCCH transmission occasion, and the first UE does not receive ACKs from all UEs in the group of UEs in the plurality of candidate PSFCH reception occasions; the PSSCH is associated with a groupcast transmission with NACK-only based feedback to a group of UEs and the first UE receives at least one NACK in any PSFCH reception occasion before the first PUCCH transmission occasion among the plurality of candidate PSFCH reception occasions; and a channel access procedure before the transmission of the PSSCH is failed at the first UE and the first UE does not transmit the PSSCH.

In some embodiments, the HARQ-ACK information corresponding to the PSSCH is the same as the sidelink HARQ-ACK feedback for the PSSCH in response to the PSSCH being associated with a unicast transmission and the sidelink HARQ-ACK feedback for the PSSCH being detected by the first UE in any candidate PSFCH reception occasion before the first PUCCH transmission occasion among the plurality of candidate PSFCH reception occasions.

In some embodiments, the HARQ-ACK information corresponding to the PSSCH includes at least two bits to indicate the first, second or third state. The BS may receive the HARQ-ACK information corresponding to the PSSCH in the first PUCCH transmission occasion.

In some embodiments, the HARQ-ACK information corresponding to the PSSCH includes at least one bit to indicate the first state or the second state. The BS may determine that the HARQ-ACK information corresponding to the PSSCH indicates the third state in response to that the BS does not detect the HARQ-ACK information in the first PUCCH transmission occasion.

In some embodiments, the BS may detect the HARQ-ACK information corresponding to the PSSCH in each of the plurality of PUCCH transmission occasions. In some embodiments, the BS may detect the HARQ-ACK information corresponding to the PSSCH from the earliest PUCCH transmission occasion of the plurality of PUCCH transmission occasions until an ACK or a NACK corresponding to the PSSCH is received by the BS in one of the plurality of PUCCH transmission occasions, and ignore the subsequent PUCCH transmission occasion(s) of the plurality of PUCCH transmission occasions.

It should be appreciated by persons skilled in the art that the sequence of the operations in exemplary method 500 may be changed and some of the operations in exemplary method 500 may be eliminated or modified, without departing from the spirit and scope of the disclosure.

FIG. 6 illustrates a block diagram of exemplary apparatus 600 according to some embodiments of the present disclosure. As shown in FIG. 6, the apparatus 600 may include at least one processor 606 and at least one transceiver 602 coupled to the processor 606. The apparatus 600 may be a UE or an NE (e.g., a BS).

Although in this figure, elements such as the at least one transceiver 602 and processor 606 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 606 may interact with each other so as to perform the operations with respect to the UE described in FIGS. 1-5. In some embodiments of the present disclosure, the apparatus 600 may be an NE (e.g., a BS). The transceiver 602 and the processor 606 may interact with each other so as to perform the operations with respect to the BS or NE described in FIGS. 1-5.

In some embodiments of the present disclosure, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602 to perform the operations with respect to the UE described in FIGS. 1-5.

In some embodiments of the present disclosure, the non-transitory computer-readable medium may have stored thereon computer-executable instructions to cause the processor 606 to implement the method with respect to the BS or NE as described above. For example, the computer-executable instructions, when executed, cause the processor 606 interacting with transceiver 602 to perform the operations with respect to the BS or NE described in FIGS. 1-5.

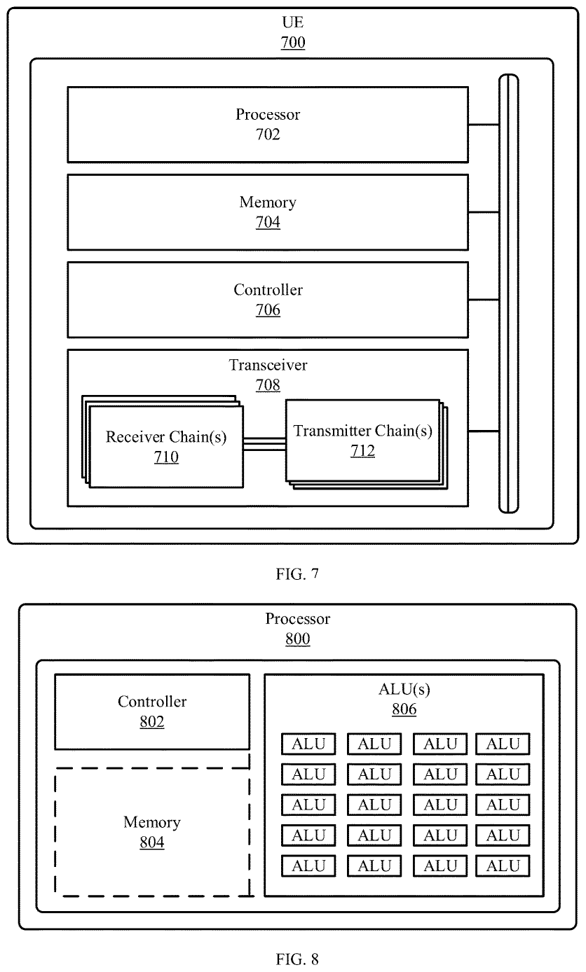

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. Anon-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. For example, the UE 700 may be configured to support means for performing the operations as described with respect to FIG. 4.

For example, the UE 700 may be configured to support: a means for receiving, from a BS (or an NE), a DCI format for scheduling a resource or activating a configured grant for transmitting a PSSCH; a means for transmitting, to a second UE, the PSSCH based on the DCI format, wherein sidelink HARQ-ACK feedback for the PSSCH is to be transmitted by the second UE in a plurality of candidate PSFCH transmission occasions; a means for detecting the sidelink HARQ-ACK feedback for the PSSCH in one or more of the plurality of candidate PSFCH transmission occasions; and a means for determining, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first PUCCH transmission occasion of a plurality of PUCCH transmission occasions.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, or packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, or packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

It should be appreciated by persons skilled in the art that the components in exemplary UE 700 may be changed, for example, some of the components in exemplary UE 700 may be omitted or modified or a new component(s) may be added to exemplary UE 700, without departing from the spirit and scope of the disclosure. For example, in some embodiments, the UE 700 may not include the controller 706.

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine a subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs, and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein.

For example, the processor 800 may be configured to support means for performing the operations as described with respect to FIG. 4. For example, the processor 800 may be configured to or operable to support: a means for receiving, from a BS (or an NE), a DCI format for scheduling a resource or activating a configured grant for transmitting a PSSCH; a means for transmitting, to a second UE, the PSSCH based on the DCI format, wherein sidelink HARQ-ACK feedback for the PSSCH is to be transmitted by the second UE in a plurality of candidate PSFCH transmission occasions; a means for detecting the sidelink HARQ-ACK feedback for the PSSCH in one or more of the plurality of candidate PSFCH transmission occasions; and a means for determining, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first PUCCH transmission occasion of a plurality of PUCCH transmission occasions.

For example, the processor 800 may be configured to support means for performing the operations as described with respect to FIG. 5. For example, the processor 800 may be configured to support: a means for transmitting, to a first UE, a DCI format for scheduling a resource or activating a configured grant for the first UE to transmit a PSSCH; a means for detecting HARQ-ACK information corresponding to the PSSCH in a first PUCCH transmission occasion of a plurality of PUCCH transmission occasions, wherein the HARQ-ACK information corresponding to the PSSCH is determined by the first UE based on received sidelink HARQ-ACK feedback for the PSSCH in one or more of a plurality of candidate PSFCH reception occasions or an absence of the sidelink HARQ-ACK feedback in the one or more of the plurality of candidate PSFCH reception occasions; and a means for determining to transmit another DCI format for scheduling retransmission of the PSSCH in response to a NACK being detected in the first PUCCH transmission occasion.

It should be appreciated by persons skilled in the art that the components in exemplary processor 800 may be changed, for example, some of the components in exemplary processor 800 may be omitted or modified or a new component(s) may be added to exemplary processor 800, without departing from the spirit and scope of the disclosure. For example, in some embodiments, the processor 800 may not include the ALUs 806.

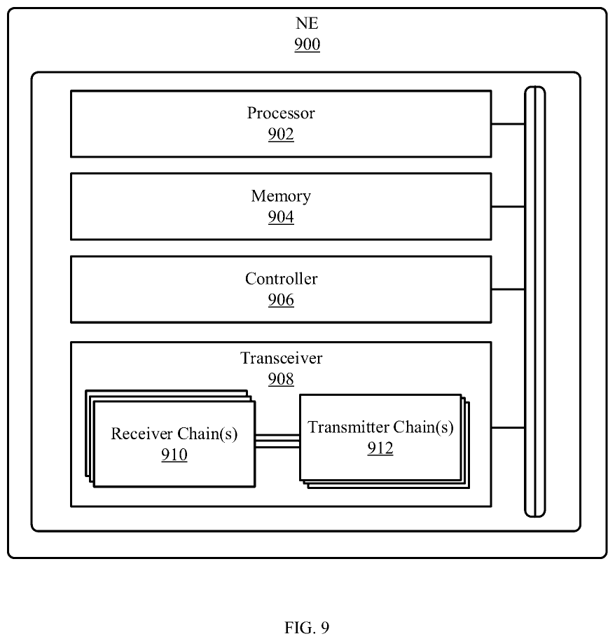

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. For example, the NE 900 may be configured to support means for performing the operations as described with respect to FIG. 5.

For example, the NE 900 may be configured to support: a means for transmitting, to a first UE, a DCI format for scheduling a resource or activating a configured grant for the first UE to transmit a PSSCH; a means for detecting HARQ-ACK information corresponding to the PSSCH in a first PUCCH transmission occasion of a plurality of PUCCH transmission occasions, wherein the HARQ-ACK information corresponding to the PSSCH is determined by the first UE based on received sidelink HARQ-ACK feedback for the PSSCH in one or more of a plurality of candidate PSFCH reception occasions or an absence of the sidelink HARQ-ACK feedback in the one or more of the plurality of candidate PSFCH reception occasions; and a means for determining to transmit another DCI format for scheduling retransmission of the PSSCH in response to a NACK being detected in the first PUCCH transmission occasion.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, or packets) over a wireless medium. For example, the receiver chain 910 may include one or more antennas for receive the signal over the air or wireless medium. The receiver chain 910 may include at least one amplifier (e.g., an LNA) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the processing the demodulated signal to receive the transmitted data.

A transmitter chain 912 may be configured to generate and transmit signals (e.g., control information, data, or packets). The transmitter chain 912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

It should be appreciated by persons skilled in the art that the components in exemplary NE 900 may be changed, for example, some of the components in exemplary NE 900 may be omitted or modified or a new component(s) may be added to exemplary NE 900, without departing from the spirit and scope of the disclosure. For example, in some embodiments, the NE 900 may not include the controller 906.

Those having ordinary skill in the art would understand that the operations or steps of the methods described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of the methods may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. The disclosure is not limited to the examples and designs described herein but is to be accorded with the broadest scope consistent with the principles and novel features disclosed herein. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” or the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

Please make the following amendments to the claims:

1. A first user equipment (UE), comprising:
at least one memory; and
at least one processor coupled with the at least one memory and configured to cause the first UE to:
receive, from a base station (BS), a downlink control information (DCI) format for scheduling a resource or activating a configured grant for transmitting a physical sidelink shared channel (PSSCH);
transmit, to a second UE, the PSSCH based on the DCI format, wherein sidelink hybrid automatic repeat request acknowledgement (HARQ-ACK) feedback for the PSSCH is to be transmitted by the second UE in a plurality of candidate physical sidelink feedback channel (PSFCH) transmission occasions;
detect the sidelink HARQ-ACK feedback for the PSSCH in one or more of the plurality of candidate PSFCH transmission occasions; and
determine, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first physical uplink control channel (PUCCH) transmission occasion of a plurality of PUCCH transmission occasions.

2. The first ULE of claim 1, wherein the HARQ-ACK information corresponding to the PSSCH indicates one of the following three states:
a first state indicating an ACK corresponding to the PSSCH;
a second state indicating a negative ACK (NACK) corresponding to the PSSCH; and
a third state indicating one of the following:
the sidelink HARQ-ACK feedback for the PSSCH is to be reported in a later PUCCH transmission occasion of the plurality of PUCCH transmission occasions;
the sidelink HARQ-ACK feedback is pending in the first PUCCH transmission occasion; and
the sidelink HARQ-ACK feedback is not obtained in a candidate PSFCH transmission occasion(s) before the first PUCCH transmission occasion in the plurality of candidate PSFCH transmission occasions and will be reported in a later PUCCH transmission occasion of the plurality of PUCCH transmission occasions.

3. The first ULE of claim 2, wherein the HARQ-ACK information corresponding to the PSSCH is determined as the third state in response to one of the following:
the PSSCH is associated with a unicast transmission, the first UE does not detect any sidelink HARQ-ACK feedback for the PSSCH before the first PUCCH transmission occasion and the plurality of candidate PSFCH transmission occasions comprises at least one candidate PSFCH transmission occasion after the first PUCCH transmission occasion;
the PSSCH is associated with a groupcast transmission with UE-specific ACK/NACK feedback to a group of UEs including the second UE, the plurality of candidate PSFCH transmission occasions comprises at least one candidate PSFCH transmission occasion after the first PUCCH transmission occasion and the first UE does not receive a NACK from any LIE in the group of UEs in any PSFCH transmission occasion before the first PUCCH transmission occasion among the plurality of candidate PSFCH transmission occasions; and
the PSSCH is associated with a groupcast transmission with NACK-only based feedback to a group of UEs including the second UE, the plurality of candidate PSFCH transmission occasions comprises at least one candidate PSFCH transmission occasion after the first PUCCH transmission occasion and the first UE does not receive a NACK in any PSFCH transmission occasion before the first PUCCH transmission occasion among the plurality of candidate PSFCH transmission occasions.

4. The first ULE of claim 2, wherein the HARQ-ACK information corresponding to the PSSCH is determined as the first state in response to one of the following:
the PSSCH is associated with a groupcast transmission with UE-specific ACK/NACK feedback to a group of UEs including the second ULE and the first UE receives ACKs from all UEs in the group of UEs in the plurality of candidate PSFCH transmission occasions; and
the PSSCH is associated with a groupcast transmission with NACK-only based feedback to a group of UEs including the second UE, the plurality of candidate PSFCH transmission occasions does not comprise a candidate PSFCH transmission occasion after the first PUCCH transmission occasion, and the first UE does not receive a NACK in all of the plurality of candidate PSFCH transmission occasions.

5. The first UE of claim 2, wherein the HARQ-ACK information corresponding to the PSSCH is determined as the second state in response to one of the following:
the PSSCH is associated with a unicast transmission, the first UE does not detect any sidelink HARQ-ACK feedback for the PSSCH before the first PUCCH transmission occasion and the plurality of candidate PSFCH transmission occasions does not comprise a candidate PSFCH transmission occasion after the first PUCCH transmission occasion;
the PSSCH is associated with a groupcast transmission with UE-specific ACK/NACK feedback to a group of UEs including the second UE and the first UE receives a NACK from any UE in the group of UEs in any PSFCH transmission occasion before the first PUCCH transmission occasion among the plurality of candidate PSFCH transmission occasions;
the PSSCH is associated with a groupcast transmission with UE-specific ACK/NACK feedback to a group of UEs including the second UE, the plurality of candidate PSFCH transmission occasions does not comprise a candidate PSFCH transmission occasion after the first PUCCH transmission occasion, and the first UE does not receive ACKs from all UEs in the group of UEs in the plurality of candidate PSFCH transmission occasions;
the PSSCH is associated with a groupcast transmission with NACK-only based feedback to a group of UEs including the second UE and the first UE receives at least one NACK in any PSFCH transmission occasion before the first PUCCH transmission occasion among the plurality of candidate PSFCH transmission occasions; and
a channel access procedure before the transmission of the PSSCH is failed at the first UE and the first UE does not transmit the PSSCH.

6. The first ULE of claim 1, wherein to determine the HARQ-ACK information corresponding to the PSSCH, the at least one processor is configured to cause the first UE to determine that the HARQ-ACK information corresponding to the PSSCH is the same as the sidelink HARQ-ACK feedback for the PSSCH in response to the PSSCH being associated with a unicast transmission and the sidelink HARQ-ACK feedback for the PSSCH being detected in any candidate PSFCH transmission occasion before the first PUCCH transmission occasion among the plurality of candidate PSFCH transmission occasions.

7. The first ULE of claim 2, wherein the HARQ-ACK information corresponding to the PSSCH comprises at least two bits to indicate the first, second or third state; and
wherein the at least one processor is further configured to cause the first ULE to transmit the HARQ-ACK information corresponding to the PSSCH to the BS in the first PUCCH transmission occasion.

8. The first UE of claim 2, wherein the HARQ-ACK information corresponding to the PSSCH comprises at least one bit to indicate the first state or the second state; and
wherein, in response to the HARQ-ACK information corresponding to the PSSCH being determined as the third state, the at least one processor is further configured to cause the first UE to not transmit the HARQ-ACK information in the first PUCCH transmission occasion.

9. The first UE of claim 1, wherein the at least one processor is further configured to cause the first UE to:
transmit the HARQ-ACK information corresponding to the PSSCH in each of the plurality of PUCCH transmission occasions; or
transmit the HARQ-ACK information indicating an ACK or a negative ACK (NACK) corresponding to the PSSCH in the first PUCCH transmission occasion of the plurality of PUCCH transmission occasions and not transmit the HARQ-ACK information in the subsequent PUCCH transmission occasion(s) after the first PUCCH transmission occasion in the plurality of PUCCH transmission occasions.

10. The first UE of claim 1, wherein the at least one processor is further configured to cause the first UE to:
transmit the HARQ-ACK information indicating an ACK or a negative ACK (NACK) corresponding to the PSSCH in the first PUCCH transmission occasion of the plurality of PUCCH transmission occasions and the subsequent PUCCH transmission occasion(s) after the first PUCCH transmission occasion in the plurality of PUCCH transmission occasions and not transmit the HARQ-ACK information corresponding to the PSSCH in each PUCCH transmission occasion before the first PUCCH transmission occasion in the plurality of PUCCH transmission occasions; or
transmit the HARQ-ACK information indicating an ACK or a NACK corresponding to the PSSCH in the first PUCCH transmission occasion and not transmit the HARQ-ACK information in all subsequent PUCCH transmission occasions in the plurality of PUCCH transmission occasions.

11. A base station (BS), comprising:
at least one memory; and
at least one processor coupled with the at least one memory and configured to cause the BS to:
transmit, to a first user equipment (UE), a downlink control information (DCI) format for scheduling a resource or activating a configured grant for the first UE to transmit a physical sidelink shared channel (PSSCH);
detect hybrid automatic repeat request acknowledgement (HARQ-ACK) information corresponding to the PSSCH in a first physical uplink control channel (PUCCH) transmission occasion of a plurality of PUCCH transmission occasions, wherein the HARQ-ACK information corresponding to the PSSCH is determined by the first UE based on received sidelink HARQ-ACK feedback for the PSSCH in one or more of a plurality of candidate physical sidelink feedback channel (PSFCH) reception occasions or an absence of the sidelink HARQ-ACK feedback in the one or more of the plurality of candidate PSFCH reception occasions; and
determine to transmit another DCI format for scheduling retransmission of the PSSCH in response to a negative ACK (NACK) being detected in the first PUCCH transmission occasion.

12. The BS of claim 11, wherein the HARQ-ACK information corresponding to the PSSCH indicates one of the following three states:
a first state indicating an ACK corresponding to the PSSCH;
a second state indicating a NACK corresponding to the PSSCH; and
a third state indicating one of the following:
the sidelink HARQ-ACK feedback for the PSSCH is to be reported by the first UE in a later PUCCH transmission occasion of the plurality of PUCCH transmission occasions;
the sidelink HARQ-ACK feedback is pending in the first PUCCH transmission occasion; and
the sidelink HARQ-ACK feedback is not obtained by the first UE in a candidate PSFCH reception occasion(s) before the first PUCCH transmission occasion in the plurality of candidate PSFCH reception occasions and will be reported by the first UE in a later PUCCH transmission occasion of the plurality of PUCCH transmission occasions.

13. The BS of claim 12, wherein the HARQ-ACK information corresponding to the PSSCH indicates the third state in response to one of the following:
the PSSCH is associated with a unicast transmission, the first UE does not detect any sidelink HARQ-ACK feedback for the PSSCH before the first PUCCH transmission occasion and the plurality of candidate PSFCH reception occasions comprises at least one candidate PSFCH reception occasion after the first PUCCH transmission occasion;
the PSSCH is associated with a groupcast transmission with UE-specific ACK/NACK feedback to a group of UEs, the plurality of candidate PSFCH reception occasions comprises at least one candidate PSFCH reception occasion after the first PUCCH transmission occasion and the first UE does not receive a NACK from any UE in the group of UEs in any PSFCH reception occasion before the first PUCCH transmission occasion among the plurality of candidate PSFCH reception occasions; and
the PSSCH is associated with a groupcast transmission with NACK-only based feedback to a group of UEs, the plurality of candidate PSFCH reception occasions comprises at least one candidate PSFCH reception occasion after the first PUCCH transmission occasion and the first UE does not receive a NACK in any PSFCH reception occasion before the first PUCCH transmission occasion among the plurality of candidate PSFCH reception occasions.

14. The BS of claim 12, wherein the HARQ-ACK information corresponding to the PSSCH indicates the first state in response to one of the following:
the PSSCH is associated with a groupcast transmission with UE-specific ACK/NACK feedback to a group of UEs and the first UE receives ACKs from all UEs in the group of UEs in the plurality of candidate PSFCH reception occasions; and
the PSSCH is associated with a groupcast transmission with NACK-only based feedback to a group of UEs, the plurality of candidate PSFCH reception occasions does not comprise a candidate PSFCH reception occasion after the first PUCCH transmission occasion, and the first UE does not receive a NACK in all of the plurality of candidate PSFCH reception occasions.

15. The BS of claim 12, wherein the HARQ-ACK information corresponding to the PSSCH indicates the second state in response to one of the following:
the PSSCH is associated with a unicast transmission, the first UE does not detect any sidelink HARQ-ACK feedback for the PSSCH before the first PUCCH transmission occasion and the plurality of candidate PSFCH reception occasions does not comprise a candidate PSFCH reception occasion after the first PUCCH transmission occasion;
the PSSCH is associated with a groupcast transmission with UE-specific ACK/NACK feedback to a group of UEs and the first UE receives a NACK from any UE in the group of UEs in any PSFCH reception occasion before the first PUCCH transmission occasion among the plurality of candidate PSFCH reception occasions;
the PSSCH is associated with a groupcast transmission with UE-specific ACK/NACK feedback to the group of UEs, the plurality of candidate PSFCH reception occasions does not comprise a candidate PSFCH reception occasion after the first PUCCH transmission occasion, and the first UE does not receive ACKs from all UEs in the group of UEs in the plurality of candidate PSFCH reception occasions;
the PSSCH is associated with a groupcast transmission with NACK-only based feedback to a group of UEs and the first UE receives at least one NACK in any PSFCH reception occasion before the first PUCCH transmission occasion among the plurality of candidate PSFCH reception occasions; and
a channel access procedure before the transmission of the PSSCH is failed at the first UE and the first UE does not transmit the PSSCH.

16. The BS of claim 11, wherein the HARQ-ACK information corresponding to the PSSCH is the same as the sidelink HARQ-ACK feedback for the PSSCH in response to the PSSCH being associated with a unicast transmission and the sidelink HARQ-ACK feedback for the PSSCH being detected by the first UE in any candidate PSFCH reception occasion before the first PUCCH transmission occasion among the plurality of candidate PSFCH reception occasions.

17. The BS of claim 12, wherein the HARQ-ACK information corresponding to the PSSCH comprises at least two bits to indicate the first, second or third state; and
wherein the at least one processor is further configured to cause the BS to receive the HARQ-ACK information corresponding to the PSSCH in the first PUCCH transmission occasion.

18. The BS of claim 12, wherein the HARQ-ACK information corresponding to the PSSCH comprises at least one bit to indicate the first state or the second state; and
wherein the at least one processor is further configured to cause the BS to determine that the HARQ-ACK information corresponding to the PSSCH indicates the third state in response to that the BS does not detect the HARQ-ACK information in the first PUCCH transmission occasion.

19. A processor for wireless communication, comprising:
at least one controller coupled with at least one memory and configured to cause the processor to:
receive, from a base station (BS), a downlink control information (DCI) format for scheduling a resource or activating a configured grant for transmitting a physical sidelink shared channel (PSSCH);
transmit, to a second user equipment (UE), the PSSCH based on the DCI format, wherein sidelink hybrid automatic repeat request acknowledgement (HARQ-ACK) feedback for the PSSCH is to be transmitted by the second UE in a plurality of candidate physical sidelink feedback channel (PSFCH) transmission occasions;
detect the sidelink HARQ-ACK feedback for the PSSCH in one or more of the plurality of candidate PSFCH transmission occasions; and
determine, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first physical uplink control channel (PUCCH) transmission occasion of a plurality of PUCCH transmission occasions.

20. A method for wireless communication performed by a first user equipment (UE), comprising:
receiving, from a base station (BS), a downlink control information (DCI) format for scheduling a resource or activating a configured grant for transmitting a physical sidelink shared channel (PSSCH);
transmitting, to a second UE, the PSSCH based on the DCI format, wherein sidelink hybrid automatic repeat request acknowledgement (HARQ-ACK) feedback for the PSSCH is to be transmitted by the second UE in a plurality of candidate physical sidelink feedback channel (PSFCH) transmission occasions;
detecting the sidelink HARQ-ACK feedback for the PSSCH in one or more of the plurality of candidate PSFCH transmission occasions; and
determining, based on the detected sidelink HARQ-ACK feedback or an absence of the sidelink HARQ-ACK feedback in the one or more of the plurality of candidate PSFCH transmission occasions, HARQ-ACK information corresponding to the PSSCH to be transmitted to the BS in a first physical uplink control channel (PUCCH) transmission occasion of a plurality of PUCCH transmission occasions.
